(19) United States
(12) Patent Application Publication
(10) Pub. No.: US 2007/0164957 A1
(43) Pub. Date: Jul. 19, 2007

(54) Liquid Crystal Display

(75) Inventors: Ming-Feng Hsieh, Tainan County (TW); Chien-Hong Chen, Tainan County (TW); Chih-Yung Hsieh, Tainan County (TW); I-Lin HO, Tainan County (TW); Che-Ming Hsu, Tainan County (TW)

Correspondence Address: LOWE HAUPTMAN BERNER, LLP, 1700 DIAGONAL ROAD, SUITE 300, ALEXANDRIA, VA, 22314, US

(73) Assignee: CHI MEI OPTOELECTRONICS CORP., Tainan County (TW)

(21) Appl. No.: 11/616,934

(22) Filed: Dec. 28, 2006

(30) Foreign Application Priority Data
Jan. 13, 2006 (TW) 95101483

(51) Int. Cl. G09G 3/36

(52) U.S. Cl. 345/90

(57) ABSTRACT

A multi-domain LCD panel includes data lines, scan lines and pixels. Each pixel includes first and second sub-pixels respectively having first and second storage capacitors. A first data switch is selectively coupled to a first terminal of the first capacitor and one of the data lines. A second data switch is selectively coupled to a first terminal of the second capacitor and one of the data lines. First and second bias lines are respectively coupled to second terminals of the first and second capacitors. When a corresponding scan line is enabled, the first and second data switches turn on such that a signal on the data line is transmitted to the first and second sub-pixels. After the scan line is disabled, levels of the first and second bias lines are changed such that pixel voltages of the first and second sub-pixels differ from each other.

This application claims the benefit of Taiwan application Serial No. 95101483, filed Jan. 13, 2006, the subject matter of which is incorporated herein by reference.

### BACKGROUND OF THE INVENTION

1. Field of the Invention

The invention relates in general to a LCD (Liquid Crystal Display) panel, and more particularly to a LCD panel having low color differences and multiple domains.

2. Description of the Related Art

The viewable angle of a typical LCD is not large, so the colors of the frame become incorrect when the display is viewed at a large tilt angle. The LCD with the larger screen suffers from the drawback of the uneven brightness over the middle and periphery portions of the frame. Thus, manufacturers have paid a great deal of attention to the development of various LCDs with wide viewing angles, such as an IPS (In-Plane Switching) LCD, a MVA (Multi-domain Vertical Alignment) LCD, and the like.

In the MVA LCD, one pixel is divided into a plurality of domains. Arranging directions of liquid crystal molecules in each domain are slightly different from one another such that the difference is not too great when the display is viewed with different viewing angles.

However, the colors of the frame of the multi-domain LCD viewed with different viewing angles still exhibit some differences, so the frame quality thereof requires further improvement.

In a conventional driving method of solving the color difference, one pixel in the LCD panel is divided into two sub-pixels each having a thin film transistor for control. Thus, the slightly different driving voltages may be respectively inputted to the two sub-pixels of the pixel so that the phenomenon of the color difference can be improved.

### SUMMARY OF THE INVENTION

The invention is directed to a multi-domain LCD, which has the low color differences and the enhanced frame quality.

According to the present invention, a LCD (Liquid Crystal Display) panel includes data lines, scan lines and pixels. Each pixel includes a first sub-pixel and a second sub-pixel, which respectively have a first storage capacitor and a second storage capacitor. A first data switch is selectively coupled to a first terminal of the first storage capacitor and one of the data lines. A second data switch is selectively coupled to a first terminal of the second storage capacitor and one of the data lines. A first bias line is coupled to a second terminal of the first storage capacitor. A second bias line is coupled to a second terminal of the second storage capacitor. When the scan line is enabled, the first data switch and the second data switch turn on such that the signal on the data line is transmitted to the first sub-pixel and the second sub-pixel. Next, after the scan line is disabled, levels of the first bias line and the second bias line are respectively changed such that pixel voltages of the first sub-pixel and the second sub-pixel slightly different from each other.

The invention will become apparent from the following detailed description of the preferred but non-limiting embodiments. The following description is made with reference to the accompanying drawings.

### BRIEF DESCRIPTION OF THE DRAWINGS

FIG. 1A shows a multi-domain LCD module according to a first embodiment of the invention.

FIG. 1B shows an equivalent circuit diagram of one portion of the LCD panel.

FIGS. 2A and 2B respectively show signal waveforms of a first sub-pixel and a second sub-pixel of the LCD panel according to a first driving method.

FIGS. 3A and 3B respectively show signal waveforms of the first sub-pixel and the second sub-pixel of the LCD panel according to a second driving method.

FIG. 4 shows an equivalent circuit diagram of a multi-domain LCD panel according to a second embodiment of the invention.

FIGS. 5A and 5B respectively show signal waveforms of the first sub-pixel and the second sub-pixel of the LCD panel according to a third driving method.

FIGS. 6A and 6B respectively show signal waveforms of the first sub-pixel and the second sub-pixel of the LCD panel 400 according to a fourth driving method.

FIGS. 7A to 7D are schematic illustrations showing a LCD having a gate driver for driving bias lines.

FIG. 8 is a schematic illustration showing a first LCD having a logic circuit for driving the bias lines.

FIGS. 9A, 10A, 11A and 12A respectively show circuit diagrams of bias units.

FIGS. 9B, 10B, 11B and 12B respectively show signal waveforms of various bias units and the corresponding first sub-pixel and the second sub-pixel.

FIGS. 13A to 13C show layouts of three pixels.

FIG. 14A is a schematic illustration showing a LCD panel 100 of the first embodiment.

FIG. 14B is a cross-sectional view taken along a line A-A to show a first LCD panel structure.

FIG. 14C is a cross-sectional view taken along the line A-A to show a second LCD panel structure.

FIG. 14D is a cross-sectional view taken along the line A-A to show a third LCD panel structure.

FIG. 14E is a cross-sectional view taken along the line A-A to show a fourth LCD panel structure.

FIG. 15A is a schematic illustration showing the LCD panel 400 of the second embodiment.

FIGS. 15B to 15E are cross-sectional views showing various structures of the LCD panel 400.

### DETAILED DESCRIPTION OF THE INVENTION

### FIRST EMBODIMENT

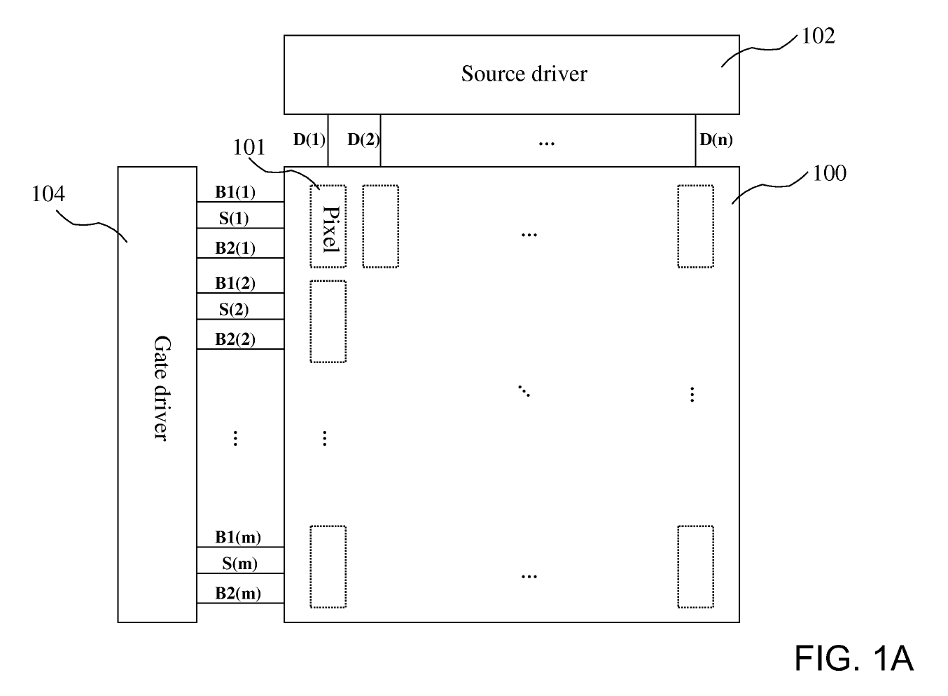

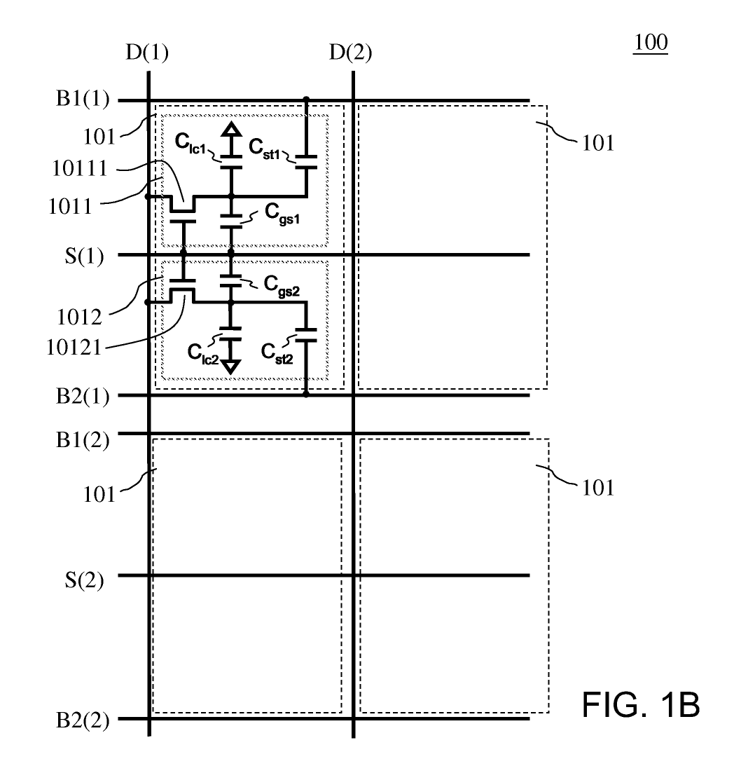

FIG. 1A shows a multi-domain LCD module according to a first embodiment of the invention. Referring to FIG. 1A, the LCD module includes a LCD panel 100, a source driver 102 and a gate driver 104. The LCD panel 100 includes n*m pixels 101. The source driver 102 transmits display data to the pixels 101 through data lines D(1) to D(n). The gate driver 104 transmits a scan signal to the LCD panel 100 to sequentially turn on each column of pixels through scan lines S(1) to S(m), and transmits a first bias signal and a second bias signal to each pixel 101 on the LCD panel 100 through first bias lines B1(1) to B1(m) and second bias lines B2(1) to B2(m).

FIG. 1B shows an equivalent circuit diagram of one portion of the LCD panel 100. Referring to FIG. 1B, the LCD panel 100 includes a plurality of pixels 101 arranged in a matrix, a first bias line B1 and a second bias line B2 parallel to each other, a plurality of parallel scan lines S and a plurality of parallel data lines D. The scan lines S, the first bias line B1 and the second bias line B2 are substantially parallel to one another and perpendicular to the data lines D. Each pixel 101 corresponds to one data line D, one scan line S, one first bias line B1 and one second bias line B2.

The pixel 101 includes a first sub-pixel 1011 and a second sub-pixel 1012. The first sub-pixel 1011 includes a thin film transistor 10111, a storage capacitor Cₛₜ₁, and a parasitic capacitor C_{gs1} formed between a gate and a source of the thin film transistor 10111. The thin film transistor 10111 has the gate coupled to the scan line S(1), the drain coupled to the data line D(1) and a source coupled to a first terminal of a liquid crystal equivalent capacitor C_{lc1} and a first terminal of the storage capacitor Cₛₜ₁. The potential of the source of the thin film transistor 10111 is vₛ₁, a second terminal of the liquid crystal equivalent capacitor C_{lc1} is coupled to a common electrode having the voltage of V_{com}, and a second terminal of the storage capacitor Cₛₜ₁ is coupled to the first bias line B1(1). The second sub-pixel 1012 includes a thin film transistor 10121, a liquid crystal equivalent capacitor C_{lc2}, a storage capacitor Cₛₜ₂ and a parasitic capacitor C_{gs2} formed between the gate and the source of the thin film transistor 10121. The thin film transistor 10121 has a gate coupled to the scan line S(1), a drain coupled to the data line D(1), and a source coupled to a first terminal of the liquid crystal equivalent capacitor C_{lc2} and a first terminal of the storage capacitor Cₛₜ₂. The potential of the source of the thin film transistor 10121 is Vₛ₂, a second terminal of the liquid crystal equivalent capacitor C_{lc2} is coupled to the common electrode having the voltage of V_{com}, and a second terminal of the storage capacitor Cₛₜ₂ is coupled to the first bias line B2(1). The storage capacitor Cₛₜ₁ of the first sub-pixel 1011 is formed by the source of the thin film transistor 10111 and the first bias line B1(n), and the storage capacitor Cₛₜ₂ of the second sub-pixel 1012 is formed by the source of the thin film transistor 10121 and the second bias line B2(n).

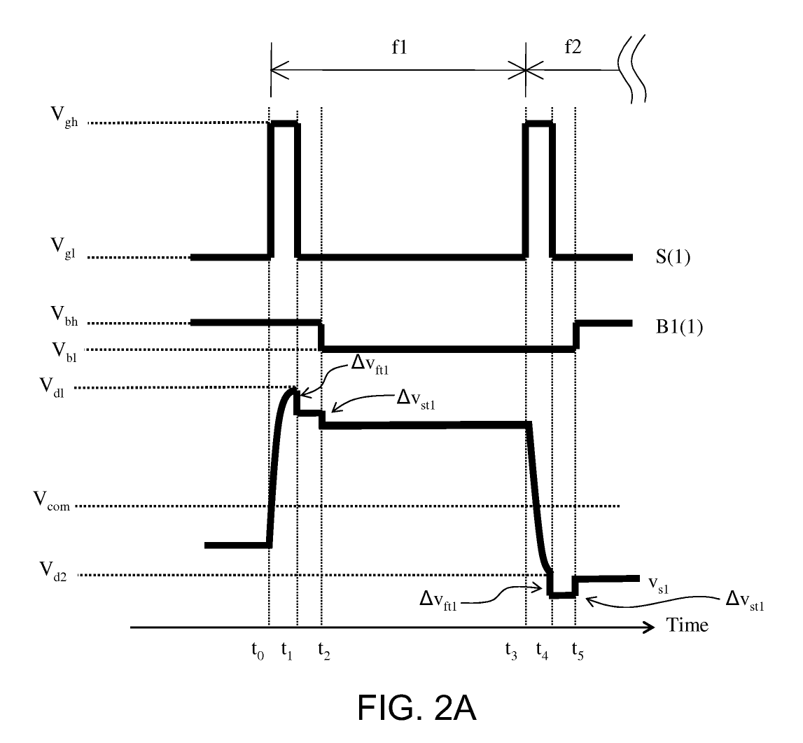

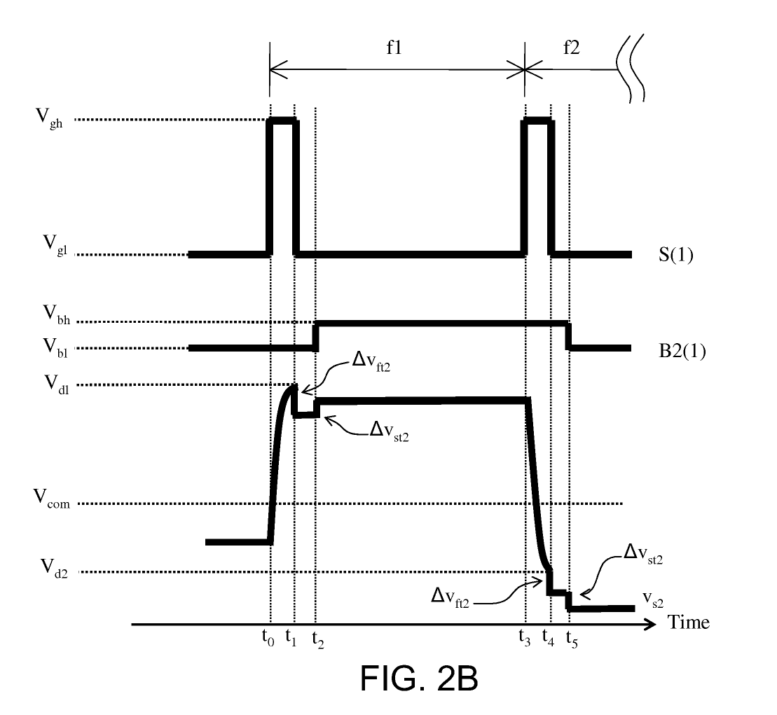

There are many methods of enabling the first sub-pixel and the second sub-pixel to generate different pixel voltages, and only two examples are illustrated in connection with this embodiment. FIGS. 2A and 2B respectively show signal waveforms of the first sub-pixel 1011 and the second sub-pixel 1012 of the LCD panel 100 according to a first driving method. Taking the polarity switching method of dot inversion as an example, in which the polarities of the pixel voltages in adjacent frame time periods of the same pixel are different from each other and the polarities of the pixel voltages of the adjacent pixels are different from each other. As shown in FIGS. 2A and 2B, at time to in the first frame time period f1, the voltage of the first bias line B1(1) is V_{bh}, the voltage of the second bias line B2(1) is V_{bl}, and the voltage of the scan line S(n) is V_{gh} such that the thin film transistor 10111 and the thin film transistor 10121 turn on. The source driver 102 transmits a display voltage V_{d1} (not shown) to the liquid crystal equivalent capacitor C_{lc1} and the liquid crystal equivalent capacitor C_{lc2} through the data line D(1). Due to the charging effect of the capacitor, the voltage difference V_{dif1} between two terminals of the liquid crystal equivalent capacitor C_{lc1} is slowly changed to (V_{d1}−V_{com}), and the voltage difference V_{dif2} between two terminals of the liquid crystal equivalent capacitor C_{lc2} is changed to (V_{d1}−V_{com}). At time t₁, the voltage of the first bias line B1(1) is still V_{bh}, and the voltage of the second bias line B2(1) is still V_{b1}. The voltage of the scan line S(n) is V_{gl} such that the thin film transistor 10111 and the thin film transistor 10121 cut off. At this moment, the voltage difference between two terminals of each of the parasitic capacitor C_{gs1} and the parasitic capacitor C_{gs2} has to be kept constant, such that the voltage difference V_{dif1} between two terminals of the liquid crystal equivalent capacitor C_{lc1} is changed from (V_{d1}−V_{com}) to (V_{d1}−V_{com}), wherein

$$Δ {v}_{f t 1} = ( {V}_{g h} - {V}_{g l} ) \times \frac{{C}_{g s 1}}{{C}_{g s 1} + {C}_{l s 1} + {C}_{s t 1}} ;$$

and the voltage difference V_{dif2} between two terminals of the liquid crystal equivalent capacitor C_{lc2} is changed from (V_{d1}−V_{com}) to

$$( {V}_{d 1} - {V}_{com} - Δ {v}_{f t 2} ) , \\ wherein \text{:}$$

$$Δ {v}_{f t 2} = ( {V}_{g h} - {V}_{g l} ) \times \frac{{C}_{g s 2}}{{C}_{g s 2} + {C}_{l c 2} + {C}_{s t 2}} .$$

This phenomenon is referred to as a feed-through effect. At time t₂, the voltage of the first bias line B1(1) is changed from V_{bh} to V_{bl}, and the voltage of the second bias line B2(1) is changed from V_{bl} to V_{bh}. At this moment, the voltage difference V_{dif1} between two terminals of the liquid crystal equivalent capacitor C_{lc2} is changed from (V_{d1}−V_{com}−Δv_{ft1}) to (V_{d1}−V_{com}−Δv_{ft1}−Δvₛₜ₁) due to the feed-through effect, wherein

$$Δ {v}_{s t 1} = ( {V}_{b h} - {V}_{b l} ) \times \frac{{C}_{s t 1}}{{C}_{g s 1} + {C}_{l c 1} + {C}_{s t 1}} ;$$

and the voltage difference V_{dif2} between two terminals of the liquid crystal equivalent capacitor C_{lc2} is changed to

$$( {V}_{d 1} - {V}_{com} - Δ {v}_{f t 2} + Δ {v}_{s t 2} ) , \\ wherein \text{:}$$

$$Δ {v}_{s t 2} = ( {V}_{b h} - {V}_{b l} ) \times \frac{{C}_{s t 2}}{{C}_{g s 2} + {C}_{l c 2} + {C}_{s t 2}} .$$

At time t₃ in the second frame time period f2, the voltage of the first bias line B1(1) is V_{bl}, the voltage of the second bias line B2(1) is V_{bh}, and the voltage of the scan line S(n) is V_{gh} to make the thin film transistor 10111 and the thin film transistor 10121 turn on. The source driver 102 transfers a display voltage V_{d2} (not shown) to the liquid crystal equivalent capacitor C_{lc1} and the liquid crystal equivalent capacitor C_{lc2} through the data line D(1). The charging effect of the capacitor makes the voltage difference V_{dif1} between two terminals of the liquid crystal equivalent capacitor C_{lc1} change to (V_{d2}−V_{com}) slowly, and makes the voltage difference V_{dif2} between two terminals of the liquid crystal equivalent capacitor C_{lc2} to change to (V_{d2}−V_{com}). At time t₄, the voltage of the first bias line B1(1) is V_{bl}, the voltage of the second bias line B2(1) is V_{bh}, and the voltage of the scan line S(n) is V_{gl} to make the thin film transistor 10111 and the thin film transistor 10121 cut off. At this moment, because the voltage difference between two terminals of each of the parasitic capacitor C_{gs1}, and the parasitic capacitor C_{gs2} has to be kept constant, the voltage difference V_{dif1} between two terminals of the liquid crystal equivalent capacitor C_{lc1} is changed to (V_{d2}−V_{com}−Δv_{ft1}), and the voltage difference V_{dif2} between two terminals of the liquid crystal equivalent capacitor C_{lc2} is changed to (V_{d2}−V_{com}−Δv_{ft2}). At time t₅, the voltage of the first bias line B1(1) is changed from V_{bl} to V_{bh}, and the voltage of the second bias line B2(1) is changed from V_{bh} to V_{bl}. At this moment, because the voltage difference between two terminals of each of the storage capacitor Cₛₜ₁ and the storage capacitor Cₛₜ₂ has to be kept constant, the voltage difference V_{dif1} between two terminals of the liquid crystal equivalent capacitor C_{lc1} is changed to (V_{d2}−V_{com}−Δv_{ft1}+Δvₛₜ₁), and the voltage difference V_{dif2} between two terminals of the liquid crystal equivalent capacitor C_{lc2} is changed to (V_{d2}−V_{com}−Δv_{ft2}−Δvₛₜ₂).

In the first frame time period f1, the driving method makes the voltage difference V_{dif1} between two terminals of the liquid crystal equivalent capacitor C_{lc1} of the first sub-pixel 1011 assume a value of (V_{d1}−V_{com}−Δv_{ft1}−Δvₛₜ₂) and makes the voltage difference V_{dif2} between two terminals of the liquid crystal equivalent capacitor C_{lc2} of the second sub-pixel 1012 assume a value of (V_{d1}−V_{com}−Δv_{ft2}+Δvₛₜ₂). With this the voltage differences between two terminals of the liquid crystal equivalent capacitors of the first sub-pixel and the second sub-pixel are different from each other and the low color difference effect can be achieved. Similarly, in the second frame time period f2, the driving method causes the voltage difference V_{dif1} between two terminals of the liquid crystal equivalent capacitor C_{lc1} of the first sub-pixel 1011 to become (V_{d2}−V_{com}−Δv_{ft1}+Δvₛₜ₁) and causes the voltage difference V_{dif2} between two terminals of the liquid crystal equivalent capacitor C_{lc2} of the second sub-pixel 1012 to become (V_{d1}−V_{com}−Δv_{ft2}−Δvₛₜ₂), such that the voltage differences between two terminals of the liquid crystal equivalent capacitors of the first sub-pixel 1011 and the second sub-pixel 1012 are slightly different from each other and the low color difference effect can be achieved. It is appreciated that, in the first frame time period f1 and the second frame time period f2, the voltage differences between two terminals of the liquid crystal equivalent capacitors of the first sub-pixel 1011 and the second sub-pixel 1012 are kept constant except that the voltage differences change as the capacitors are charged and at B1(1) and B2(1). Thus, the frame stability can be held.

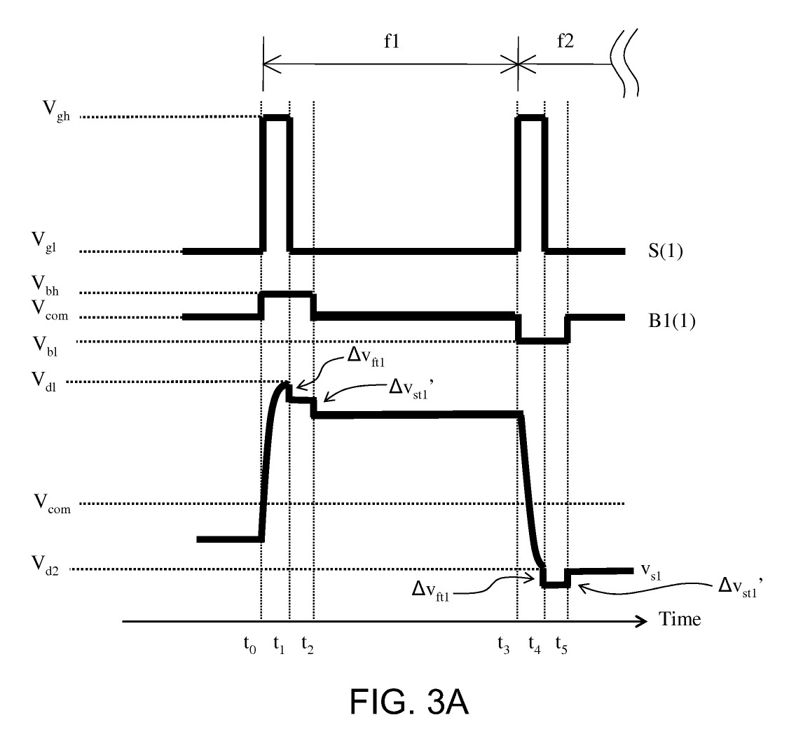

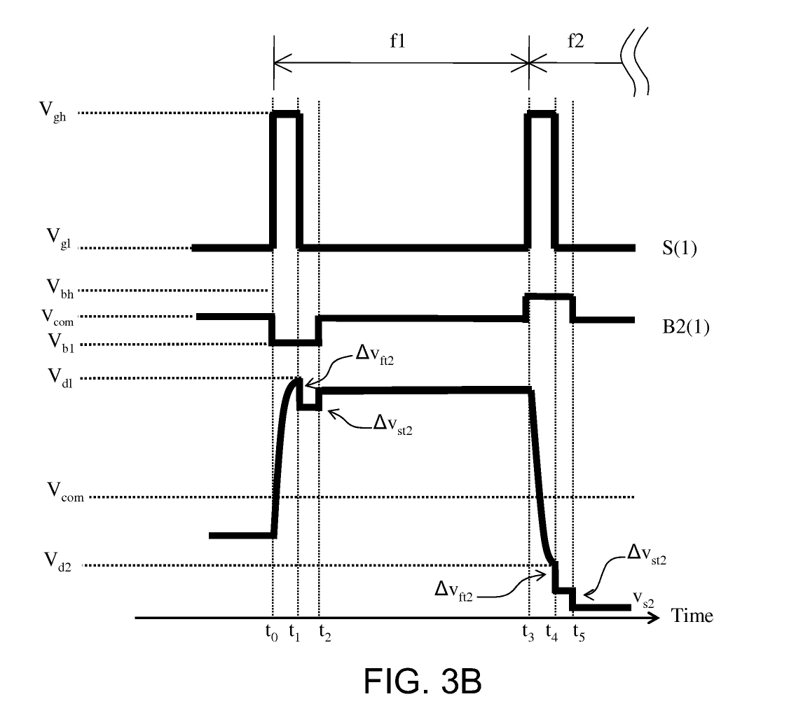

FIGS. 3A and 3B respectively show signal waveforms of the first sub-pixel and the second sub-pixel of the LCD panel 100 according to a second driving method. The second driving method mainly differs from the first driving method as follows: the first driving method only changes the states of the first bias line B1(1) and the second bias line B2(1) after the scan line S is disabled, while the second driving method changes the states of the first bias line B1(1) and the second bias line B2(1) when the scan line S is enabled and after the scan line S is disabled.

At time to in the first frame time period f1, the voltage of the first bias line B1(1) increases from V_{com} to V_{bh}, the voltage of the second bias line B2(1) decreases from V_{com} to V_{bl}, and the voltage of the scan line S(n) is V_{gh}. Thus, the thin film transistor 10111 and the thin film transistor 10121 turn on, and the source driver 102 transfers the display voltage V_{d1} (not shown) to the liquid crystal equivalent capacitor C_{lc1} and the liquid crystal equivalent capacitor C_{lc2} through the data line D(1). The capacitor charging effect enables the voltage difference V_{dif1} between two terminals of the liquid crystal equivalent capacitor C_{lc1} to change to (V_{d1}−V_{com}) slowly, and the voltage difference V_{dif2} between two terminals of the liquid crystal equivalent capacitor C_{lc2} to change to (V_{d1}−V_{com}) slowly. So, the voltage of the first bias line B1(1) is still V_{bh}, the voltage of the second bias line B2(1) is still V_{bl} and the voltage of the scan line S(n) is V_{gl} at time t₁, such that the thin film transistor 10111 and the thin film transistor 10121 cut off. At this moment, the voltage difference V_{dif1} between two terminals of liquid crystal equivalent capacitor C_{lc1} is changed from (V_{d1}−V_{com}) to (V_{d1}−V_{com}−Δv_{ft1}) due to the feed-through effect, wherein

$$Δ {v}_{f t 1} = ( {V}_{g h} - {V}_{g l} ) \times \frac{{C}_{g s 1}}{{C}_{g s 1} + {C}_{l c 1} + {C}_{s t 1}} ;$$

and the voltage difference V_{dif2} between two terminals of the liquid crystal equivalent capacitor C_{lc2} is changed from (V_{d1}−V_{com}) to (V_{d1}−V_{com}−Δv_{ft2}), wherein

$$Δ {v}_{f t 2} = ( {V}_{g h} - {V}_{g l} ) \times \frac{{C}_{g s 2}}{{C}_{g s 2} + {C}_{l c 2} + {C}_{s t 2}} .$$

Later, at time t₂, the voltage of the first bias line B1(1) decreases from V_{bh} to V_{com}, the voltage of the second bias line B2(1) increases from V_{bl} to V_{com}. At this moment, due to the feed-through effect, the voltage difference v_{dif1} between two terminals of liquid crystal equivalent capacitor C_{lc2} is changed from (V_{d1}−V_{com}−Δv_{ft1}) to (V_{d1}−V_{com}−Δv_{ft1}−Δvₛₜ₁′), wherein

$$Δ {v}_{s t 1}^{′} = ( {V}_{b h} - {V}_{com} ) \times \frac{{C}_{s t 1}}{{C}_{g s 1} + {C}_{l c 1} + {C}_{s t 1}} ;$$

and the voltage difference v_{dif2} between two terminals of the liquid crystal equivalent capacitor C_{lc2} is changed to (V_{d1}−V_{com}−Δv_{ft2}+Δvₛₜ₂′), wherein

$$Δ {v}_{s t 2}^{′} = ( {V}_{com} - {V}_{b l} ) \times \frac{{C}_{s t 2}}{{C}_{g s 2} + {C}_{l c 2} + {C}_{s t 2}} .$$

At time t₃ in the second frame time period f2, the voltage of the first bias line B1(1) decreases from V_{com} to V_{bl}, the voltage of the second bias line B2(1) increases from V_{com} to V_{bh}, and the voltage of the scan line S(n) is V_{gh} such that the thin film transistor 10111 and the thin film transistor 10121 turn on. The source driver 102 transfers the display voltage V_{d2} (not shown) to the liquid crystal equivalent capacitor C_{lc1} and the liquid crystal equivalent capacitor C_{lc2} through the data line D(1). Due to the capacitor charging effect, the voltage difference v_{dif1} between two terminals of the liquid crystal equivalent capacitor C_{lc1} is changed to (V_{d2}−V_{com}) slowly, and the voltage difference V_{dif2} between two terminals of the liquid crystal equivalent capacitor C_{lc2} is changed to (V_{d2}−V_{com}) slowly. At time t₄, the voltage of the first bias line B1(1) is still V_{bl}, the voltage of the second bias line B2(1) is still V_{bh} and the voltage of the scan line S (n) is still V_{gl} such that the thin film transistor 10111 and the thin film transistor 10121 cut off. At this moment, due to the feed-through effect, the voltage difference V_{dif1} between two terminals of the liquid crystal equivalent capacitor C_{lc1} is changed to (V_{d2}−V_{com}−Δv_{ft1}), and the voltage difference V_{dif2} between two terminals of the liquid crystal equivalent capacitor C_{lc2} is changed to (V_{d2}−V_{com}−Δv_{ft2}). Later, at time t₅, the voltage of the first bias line B1(1) increases from V_{bl} to V_{com}, the voltage of the second bias line B2(1) decreases from V_{bh} to V_{com}. At this moment, due to the feed-through effect, the voltage difference v_{dif1} between two terminals of the liquid crystal equivalent capacitor C_{lc1} is changed to (V_{d2}−V_{com}−Δv_{ft1}+Δvₛₜ₁′), and the voltage difference V_{dif2} between two terminals of the liquid crystal equivalent capacitor C_{lc2} is changed to (V_{d2}−V_{com}−Δv_{ft2}−Δvₛₜ₂′).

The first and second driving methods assume the phase difference of 180 degrees between the levels of the first bias line B1(1) and the second bias line B2(1), so the voltage differences between two terminals of the liquid crystal equivalent capacitors of the first sub-pixel 1011 and the second sub-pixel 1012 are slightly different from each other, and the low color difference effect can be achieved.

In addition to the 180 degrees of this embodiment, the phase difference between the first bias line B1(1) and the second bias line B2(1) may also range from 180 to 360 degrees. In addition, in one frame time period, the number of switching time(s) of the first bias line B1(1) and the second bias line B2(1) is one in this embodiment but may be two or more than two in other embodiments.

It is appreciated that, in the first frame time period f1 and the second frame time period f2, the voltage differences between two terminals of the liquid crystal equivalent capacitors of the first sub-pixel 1011 and the second sub-pixel 1012 are kept constant except that the voltage differences change as the capacitors are charged. Thus, the frame stability can be held.

### SECOND EMBODIMENT

FIG. 4 shows an equivalent circuit diagram of a multi-domain LCD panel according to a second embodiment of the invention. Referring to FIG. 4, the LCD panel 400 includes a plurality of pixels 401 arranged in a matrix, a plurality of parallel bias lines B, a plurality of parallel scan lines S and a plurality of parallel data lines D, wherein the bias lines B and the scan lines S are alternately arranged in parallel and perpendicular to the data lines D. The pixel 401 includes a corresponding data line D, a corresponding scan line S and a corresponding bias line B.

The pixel 401 includes a first sub-pixel 4011 and a second sub-pixel 4012. The first sub-pixel 4011 includes a thin film transistor 40111, a liquid crystal equivalent capacitor C_{lc1} and a storage capacitor Cₛₜ₁. The second sub-pixel 4012 includes a thin film transistor 40121, a liquid crystal equivalent capacitor C_{lc2} and a storage capacitor Cₛₜ₂.

The difference between the LCD panel 400 of the second embodiment and the LCD panel 100 of the first embodiment will be described in the following. Two adjacent bias lines B are merged into one bias line in the LCD panel 400. That is, one bias line B of the LCD panel 400 simultaneously adjusts the second sub-pixel of an upper pixel and the first sub-pixel of a lower pixel. Thus, the number of the bias lines may be reduced to one half. The phases of the voltages of the adjacent bias line B(n) and bias line B(n+1) are different from each other.

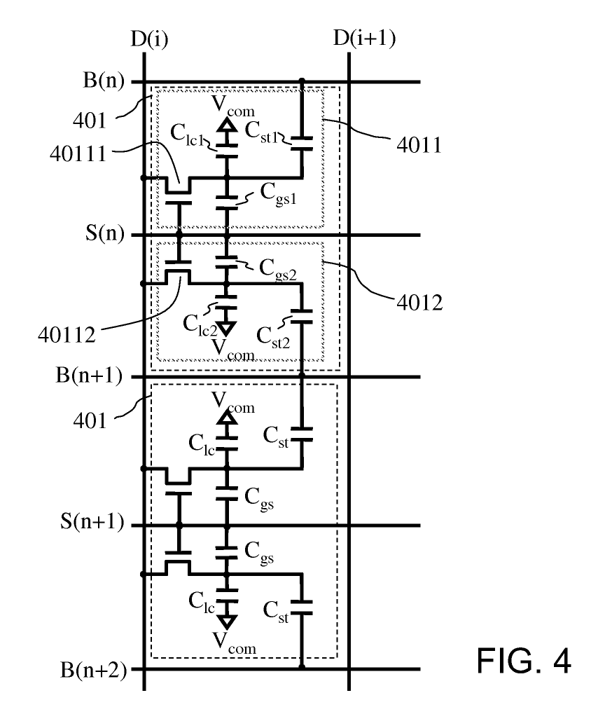

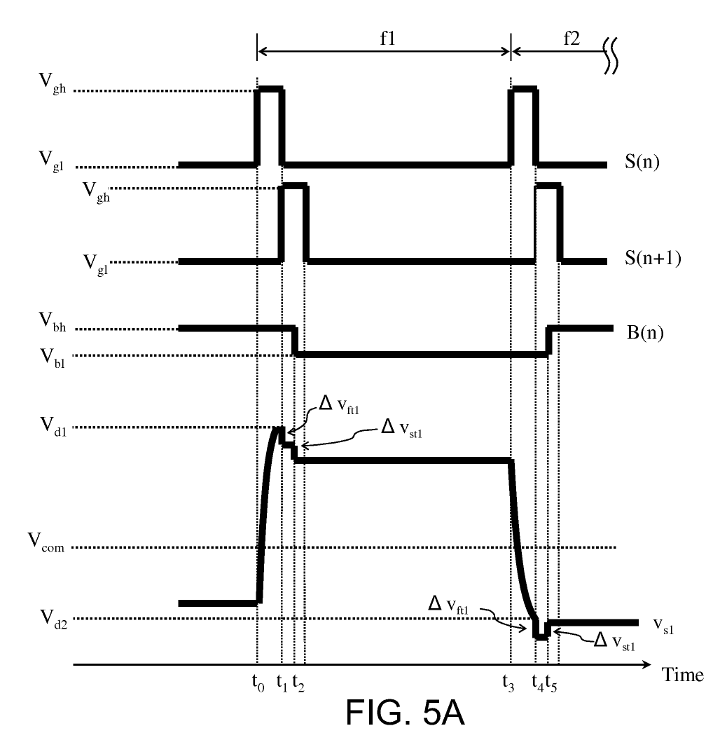

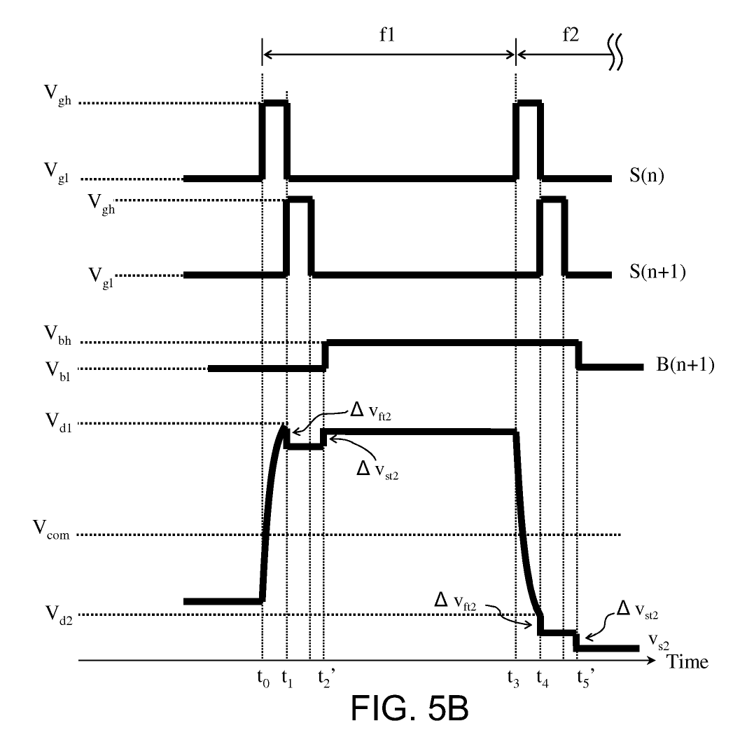

FIGS. 5A and 5B respectively show signal waveforms of the first sub-pixel and the second sub-pixel of the LCD panel 400 according to a third driving method. The signal waveform (FIG. 5A) for driving the first sub-pixel 4011 according to the third driving method is the same as the signal waveform (FIG. 2A) for driving the first sub-pixel 1011 according to the first driving method of the first embodiment, and detailed descriptions thereof will be omitted.

The difference between the signal waveform (FIG. 5B) for driving the second sub-pixel 4012 of the LCD panel 400 according to the third driving method and that (FIG. 2B) for driving the second sub-pixel 1012 of the LCD panel 100 according to the first driving method of the first embodiment resides in the signal of the bias line B. At time to in the first frame time period f1, the voltage of the bias line B(n+1) is V_{bl} and the voltage of the scan line S(n) is V_{gh} such that the thin film transistor 40111 and the thin film transistor 40121 turn on. At time t₁, the voltage of the bias line B(n+1) is still V_{bl} and the voltage of the scan line S(n) is decreased to V_{gl} such that the thin film transistor 40111 and the thin film transistor 40121 cut off. It is appreciated that the disabled scan line S(n) cannot directly and immediately increase the voltage of the bias line B2, as shown in FIG. 2B because the bias line B(n+1) still has to adjust the first sub-pixel of the lower pixel. Thus, the voltage of the bias line B(n+1) cannot be increased from V_{bl} to V_{bh} until the scan line S(n+1) of the lower pixel is enabled and disabled at time t₂′.

At time t₃ in the second frame time period f2, the voltage of the bias line B(n+1) is V_{bh} and the voltage of the scan line S(n) is V_{gh} such that the thin film transistor 40111 and the thin film transistor 40121 turn on. At time t₄, the voltage of the bias line B(n+1) is still V_{bh} and the voltage of the scan line S(n) is decreased to V_{gl} such that the thin film transistor 40111 and the thin film transistor 40121 cut off. It will be appreciated that the disabled scan line S(n) cannot directly and immediately reduce the voltage of the bias line B, as shown in FIG. 2B, because the bias line B(n+1) still has to adjust the first sub-pixel of the lower pixel. Thus, after the scan line S(n+1) of the lower pixel being disabled before time t5′, the voltage of the bias line B(n+1) is reduced from V_{bh} to V_{bl} at time t5′.

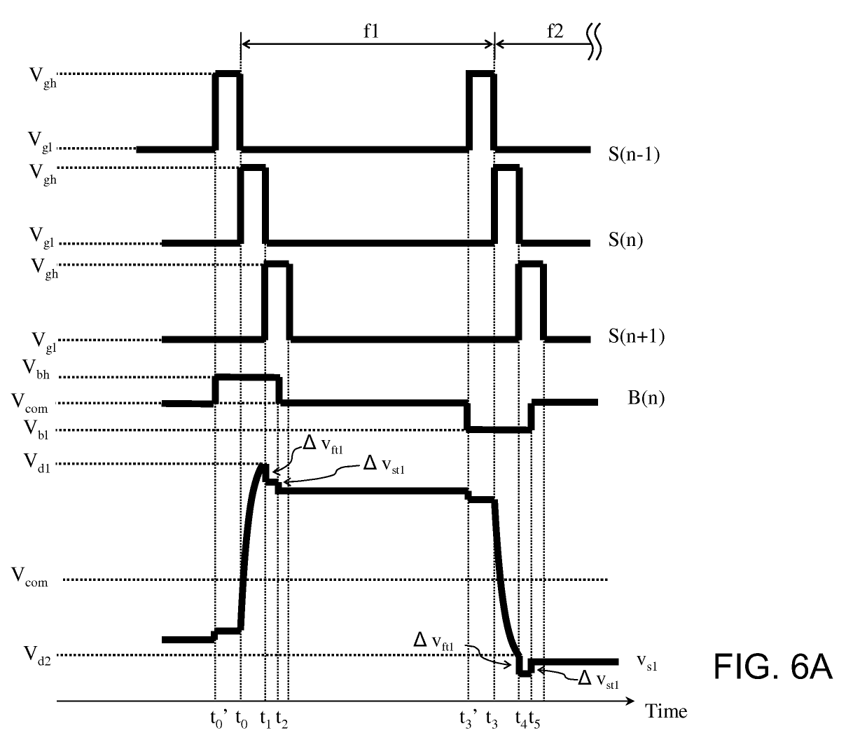

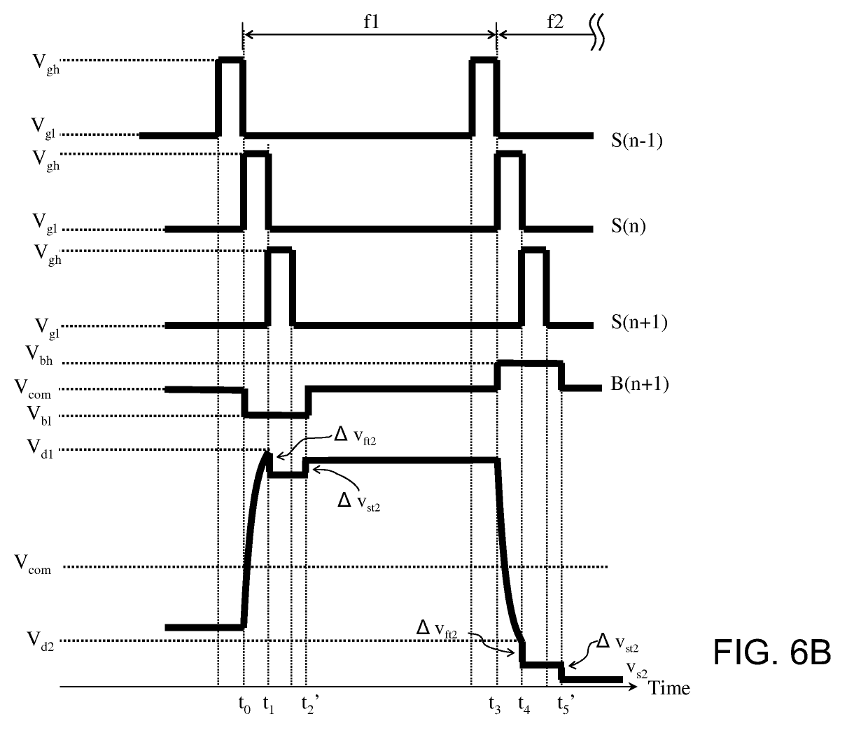

FIGS. 6A and 6B respectively show signal waveforms of the first sub-pixel and the second sub-pixel of the LCD panel 400 according to a fourth driving method. In the first frame time period f1, the voltage on the bias line B(n) has to be changed from V_{com} to V_{bh} at the time t₀′ when the scan line S(n−1) is enabled because the bias line B(n) still has to adjust the second sub-pixel of the upper pixel. After the scan line S(n) is disabled, the voltage on the bias line B(n) is changed from V_{com} to V_{bl} at time t₂; and the voltage on the bias line B(n+1) is changed from V_{com} to V_{bl} at the time t₀. However, the voltage on the bias line B(n+1) cannot be changed from V_{bl} to V_{com} until the scan line S(n+1) is disabled at time t₂′ because the bias line B(n+1) still has to adjust the first sub-pixel of the lower pixel. In the second frame time period f2, because the bias line B(n) still has to adjust the second sub-pixel of the upper pixel, the voltage on the bias line B(n) has to be changed from V_{com} to V_{bl} at the time t₃′ when the scan line S(n−1) is enabled. After the scan line S(n) is disabled, the voltage on the bias line B(n) is changed from V_{bl} to V_{com} at time t₅. The voltage on the bias line B(n+1) is changed from V_{com} to V_{bh} at time t₃. However, the bias line B(n+1) still has to adjust the first sub-pixel of the lower pixel. Thus, the voltage on the bias line B(n+1) cannot be changed from V_{bh} to V_{com} at time t₅′ after the scan line S(n+1) is disabled.

Method of Driving Bias Lines

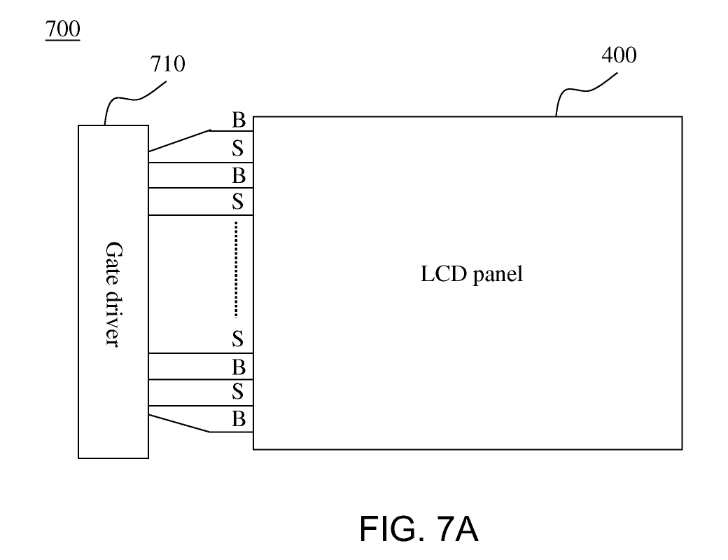

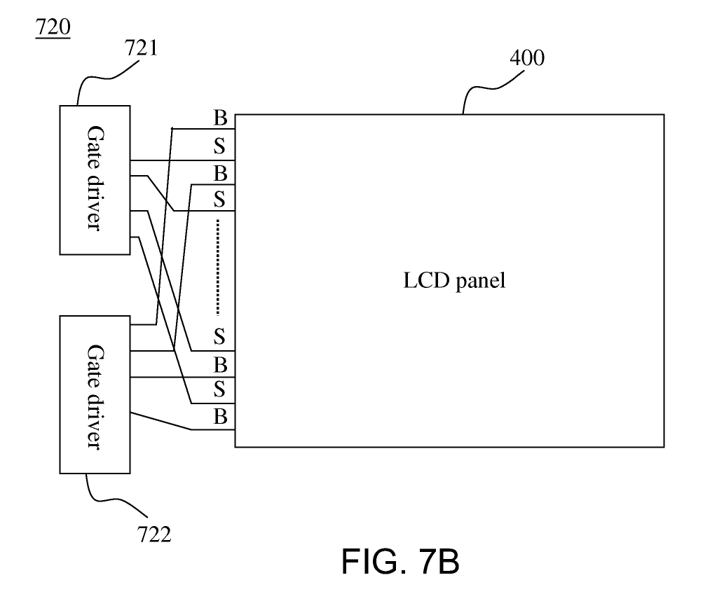

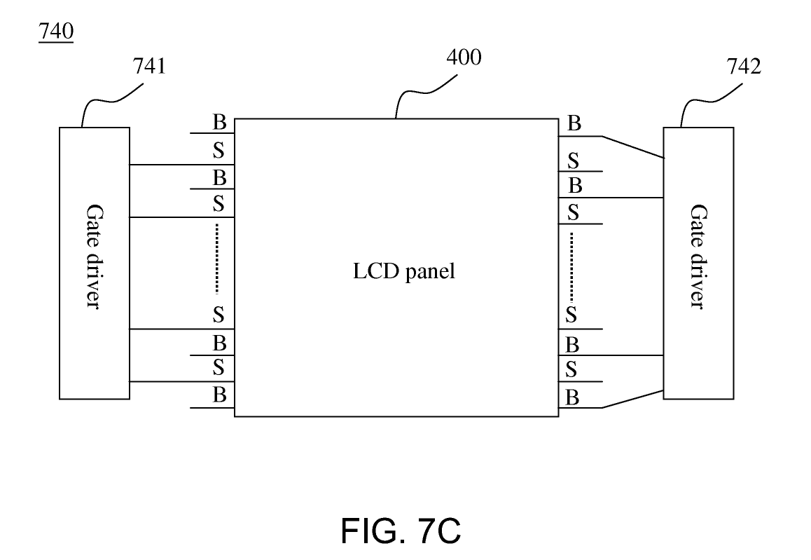

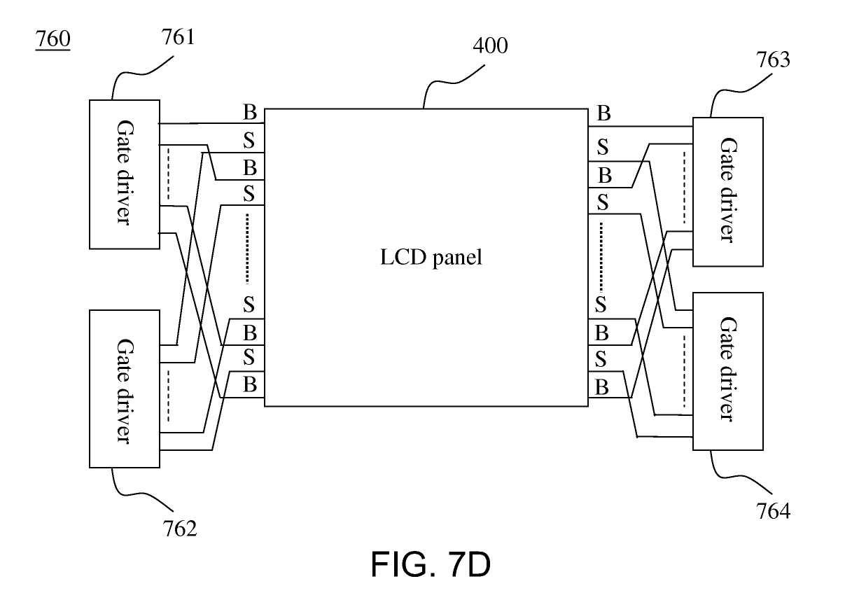

The bias lines may be driven by a gate driver or a logic circuit in this example. However, one of ordinary skill in the art may achieve the driving method of the invention according to any other arbitrary device or method. FIGS. 7A to 7D are schematic illustrations showing a LCD having a gate driver for driving bias lines. FIG. 7A is a schematic illustration showing a first LCD 700 having a gate driver for driving the bias lines, wherein the LCD panel 400 serves as an example. The LCD 700 includes the LCD panel 400 and at least one gate driver 710. Output levels of pins of the gate driver 710 may be respectively set, and the pins may be electrically connected to the corresponding scan lines S or bias lines B such that the pins respectively output the levels for the scan signals S and the bias lines B.

FIG. 7B is a schematic illustration showing a second LCD 720 having a gate driver for driving the bias lines. The LCD 720 includes the LCD panel 400 and gate drivers 721 and 722. The gate driver 721 generates the scan signal S, and the gate driver 722 generates the level for the bias line B.

FIG. 7C is a schematic illustration showing a third LCD 740 having a gate driver for driving the bias lines. The LCD 740 includes the LCD panel 400 and gate drivers 741 and 742. What is different from the LCD 720 is that the gate driver 742 drives the bias line B from the second terminal of the panel.

FIG. 7D is a schematic illustration showing a fourth LCD 760 having a gate driver for driving the bias lines. The LCD 760 includes the LCD panel 400 and gate drivers 761, 762, 763 and 764. The gate drivers 761 and 763 commonly drive the bias line B respectively from two ends of the LCD panel 400, and the gate drivers 762 and 764 commonly drives the scan line S respectively from the two ends of the LCD panel 400.

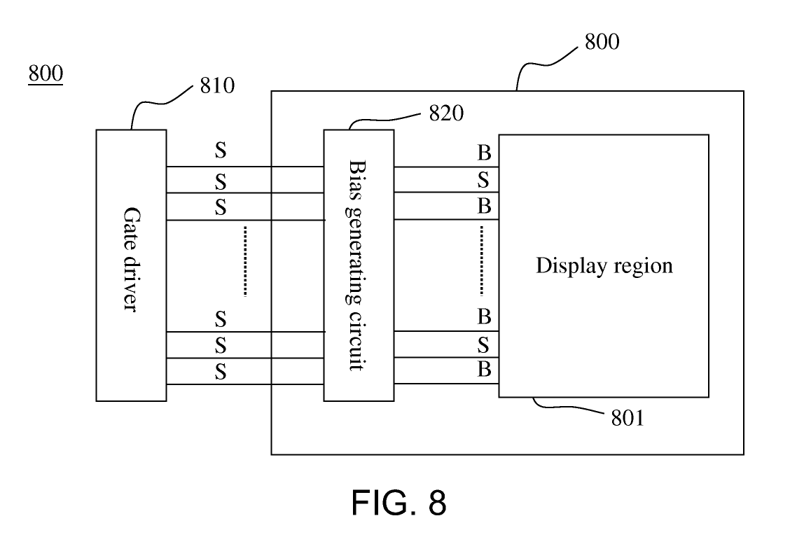

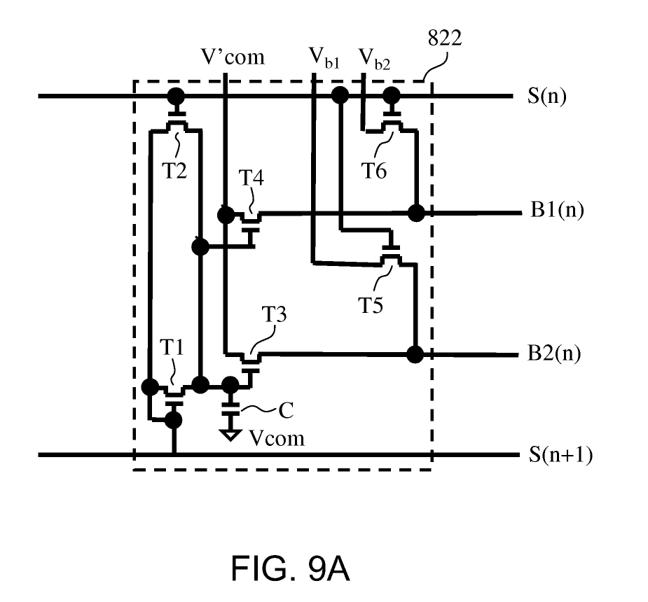

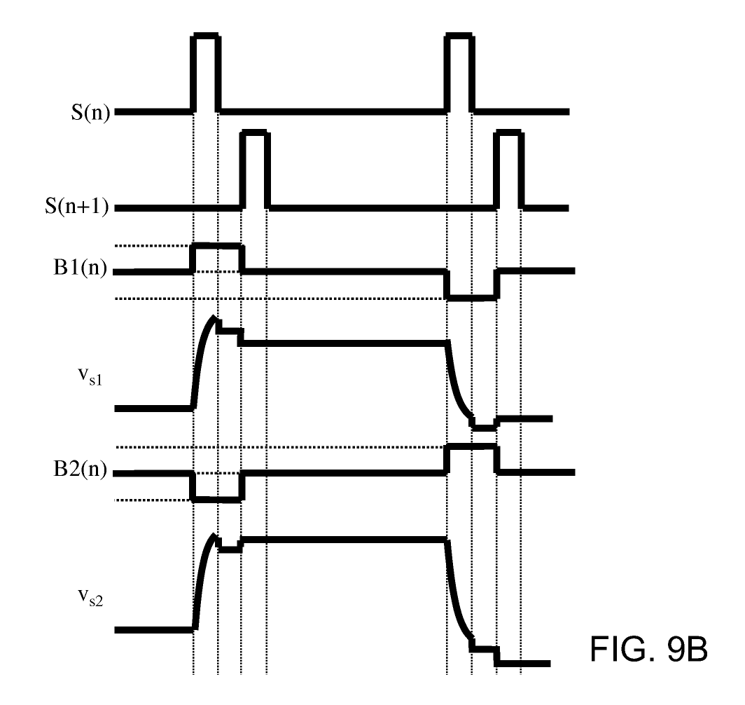

Hereinafter, a LCD using a logic circuit to drive the bias lines will be described. FIG. 8 is a schematic illustration showing a first LCD 800 having a logic circuit for driving the bias lines. The LCD 800 includes a gate driver 810, a bias generating circuit 820 and the LCD panel 400. The bias generating circuit 820 is formed on a glass substrate of the LCD panel 400. The gate driver 810 drives the scan line S. The bias generating circuit 820 drives the bias line B according to the scan line S. The bias generating circuit 820 includes a plurality of bias units, each of which generates a voltage level for the bias line according to two adjacent scan lines corresponding to the bias line. The bias unit 822 may be implemented in many ways. Four ways will be illustrated in this embodiment, as shown in FIGS. 9A, 10A, 11A and 12A. However, one of ordinary skill in the art will easily understand that the voltage level for the bias line of the invention may be generated using any other devices or methods.

FIG. 9A is a circuit diagram showing the first bias unit 822 configured to be electrically connected to the scan lines S(n) and S(n+1) in this example. The bias unit 822 includes thin film transistors T1 to T6 and a capacitor C. Please refer also to FIG. 9B, which shows signal waveforms of the bias unit 822 and its corresponding first sub-pixel and second sub-pixel. In the first frame time period f1, the scan line S(n) is enabled such that the transistors T2, T5, T6 turn on. So, the levels on the bias lines B1(n) and B2(n) are respectively changed to the levels of V_{bl} and V_{b2}. After the scan line S(n) is disabled and when the scan line S(n+1) is enabled, the transistors T2, T5, T6 turn off, and the transistors T1, T3 and T4 turn on. Thus, the levels on the bias lines B1(n) and B2(n) are changed to V_{com}, which may also be the voltage V_{com} of the common electrode.

If the polarity switching method by dot inversion is utilized, the polarities of the voltages V_{b1} and V_{b2} have to be changed with the switching of each frame. In addition, one of the voltages V_{b1} and V_{b2} may be set to be equal to the voltage V′_{com}. The transistors T3 and T5 may be eliminated if the voltage V_{b1} is equal to V′_{com}, and the transistors T4 and T6 may be eliminated if the voltage V_{b2} is equal to V′_{com}.

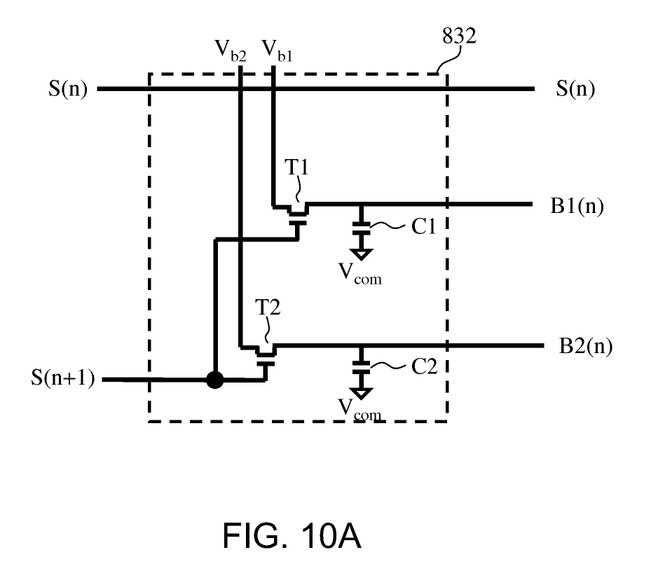

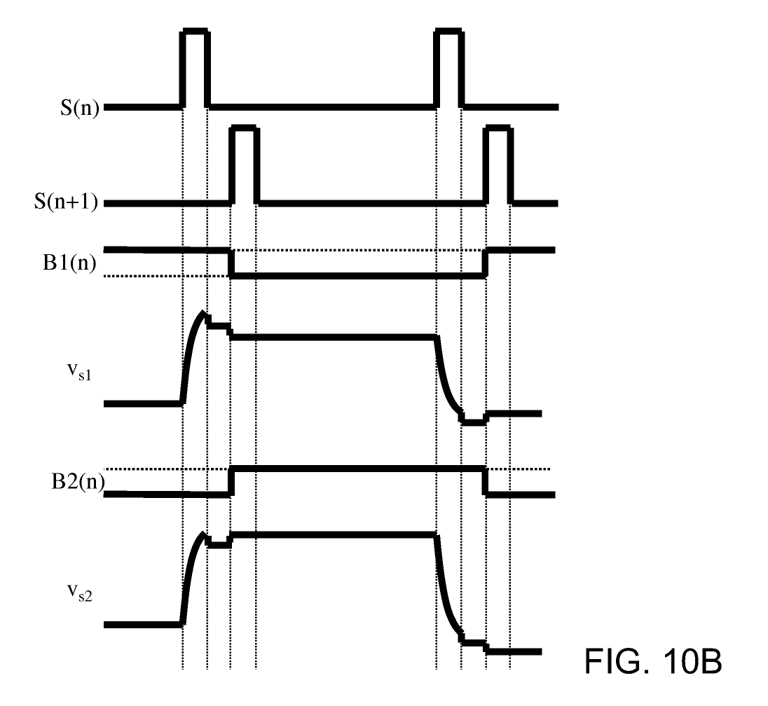

FIG. 10A is a circuit diagram showing a second bias unit 832, which is to be electrically connected to the scan lines S(n) and S(n+1) in this example. The bias unit 832 includes thin film transistors T1 and T2 and capacitors C1 and C2. Please also refer to FIG. 10B, which shows signal waveforms of the bias unit 832 and its corresponding first sub-pixel and second sub-pixel. In the first frame time period f1, the scan line S(n) is enabled and the transistors T1 and T2 turn off, so the levels of the bias lines B1(n) and B2(n) are the levels of V_{b1} and V_{b2} in the previous frame time period f0. When the scan line S(n+1) is enabled, the transistors T1 and T2 turn on. Thus, the levels on the bias lines B1(n) and B2(n) are respectively changed to V_{b1} and V_{b2} in the first frame time period f1.

If the polarity switching method by dot inversion is utilized, the polarities of the voltages V_{b1} and V_{b2} have to be switched with the switching of each frame. The polarity of V_{b1} in the previous frame time period f0 is different from that of V_{b1} in the first frame time period f1; and the polarity of V_{b2} in the previous frame time period f0 is different from that of V_{b2} in the first frame time period f1. In addition, one of the voltages V_{b1} and V_{b2} may be set to be equal to the voltage V_{com}. If the voltage V_{b1} is equal to V_{com}, the transistor T1 and the capacitor C1 may be eliminated; and if the voltage V_{b2} is equal to V_{com}, the transistor T2 and the capacitor C2 can be eliminated.

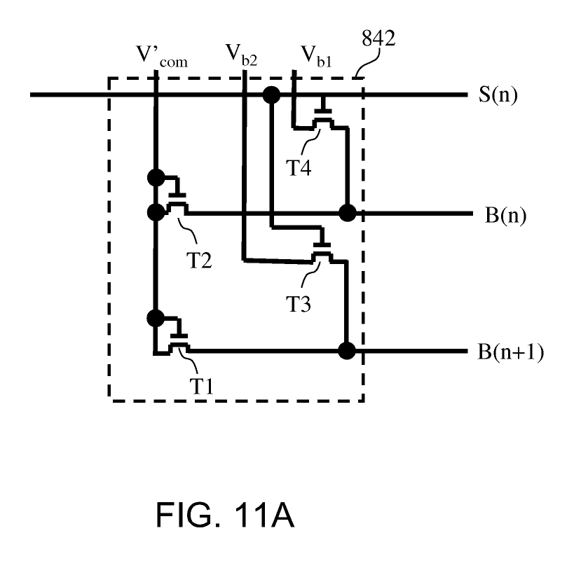

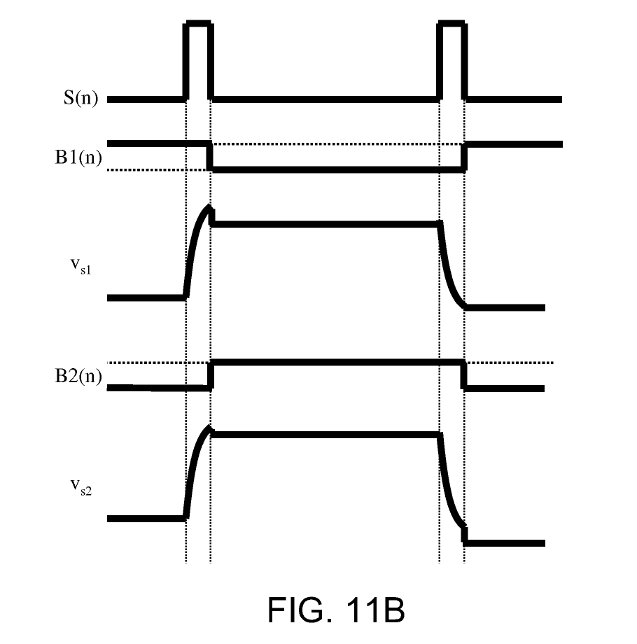

FIG. 11A is a circuit diagram showing a third bias unit 842 configured to be electrically connected to the scan line S(n). The bias unit 842 includes thin film transistors T1 to T4, wherein the transistors T1 and T2 always turn on to serve as resistors. Please refer also to FIG. 11B, which shows signal waveforms of the bias unit 842 and its corresponding first sub-pixel and second sub-pixel. In the first frame time period f1, the scan line S(n) is enabled such that the transistors T3 and T4 turn on. So, the levels of the bias lines B1(n) and B2(n) are respectively changed to the levels of V_{b1} and V_{b2}. After the scan line S(n) is disabled and when the scan line S(n+1) is enabled, the transistors T3 and T4 turn off. So, the levels of the bias lines B1(n) and B2(n) are changed to V′_{com}.

If the polarity switching method by dot inversion is utilized, the polarities of the voltages V_{b1} and V_{b2} have to be changed with the switching of each frame. The polarity of V_{b1} in the previous frame time period f0 is different from that of V_{b1} in the first frame time period f1. The polarity of V_{b2} in the previous frame time period f0 is different from that of V_{b2} in the first frame time period f1. In addition, one of the voltages V_{b1} and V_{b2} may be set to be equal to the voltage V_{com}. If the voltage V_{b1} is equal to V′_{com}, the transistors T2 and T4 may be eliminated. If the voltage V_{b2} is equal to V_{com}, the transistors T1 and T3 may be eliminated.

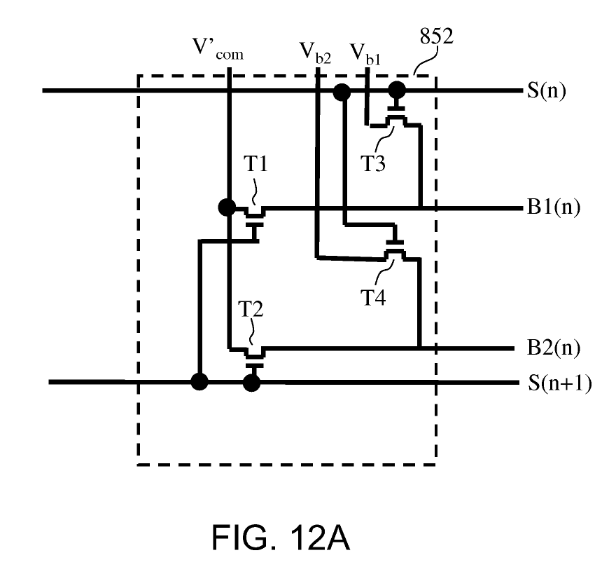

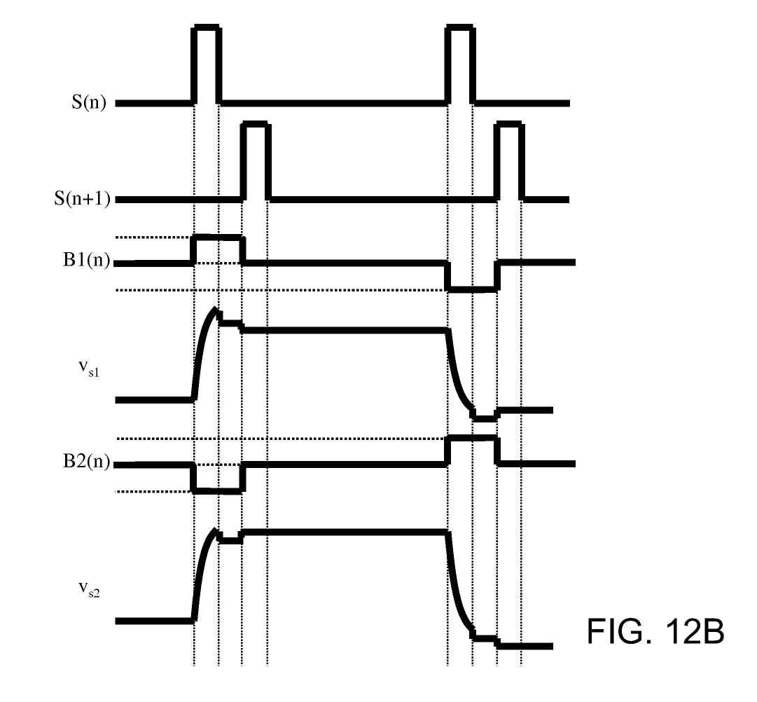

FIG. 12A is a circuit diagram showing a fourth bias unit 852, which is electrically connected to the scan lines S(n) and S(n+1) in this example. The bias unit 852 includes thin film transistors T1 to T4. Please refer also to FIG. 12B, which shows signal waveforms of the bias unit 852 and its corresponding first sub-pixel and second sub-pixel. In the first frame time period f1, the scan line S(n) is enabled such that the transistors T3 and T4 turn on. Accordingly, the levels of the bias lines B1(n) and B2(n) are respectively changed to the levels of V_{b1} and V_{b2}. After the scan line S(n) is disabled and when the scan line S(n+1) is enabled, the transistors T3 and T4 turn off, the transistors T1 and T2 turn on, and the levels of the bias lines B1(n) and B2(n) are changed to V′_{com}.

If the polarity switching method by the dot inversion is utilized, the polarities of the voltages V_{b1} and V_{b2} have to be switched with the switching of each frame. In addition, one of the voltages V_{b1} and V_{b2} may be set to be equal to the voltage V′_{com}. If the voltage V_{b1} is equal to V′_{com}, the transistors T1 and T3 may be eliminated and B1(n) is directly coupled to V′_{com}. If the voltage V_{b2} is equal to V_{com}′, the transistors T2 and T4 may be eliminated, and B2(n) is directly coupled to V′_{com}.

Pixel Layout

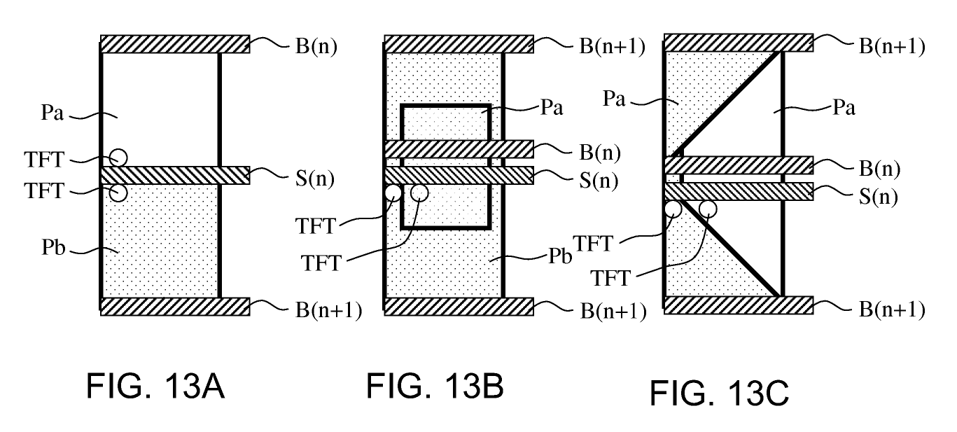

The first and second embodiments divide one pixel into a first sub-pixel Pa and a second sub-pixel Pb, and the layouts of the first sub-pixel Pa and the second sub-pixel Pb may have any arbitrary shape. Some examples will be described in the following. FIG. 13A shows a first layout of the pixel, wherein the first sub-pixel Pa and the second sub-pixel Pb respectively occupy upper and lower portions of the pixel, and each of the first sub-pixel Pa and the second sub-pixel Pb includes one TFT (Thin-Film Transistor). FIG. 13B shows a second layout of the pixel, wherein the first sub-pixel Pa is located in the middle of the pixel, the second sub-pixel Pb surrounds the first sub-pixel Pa, and each of the first sub-pixel Pa and the second sub-pixel Pb includes one TFT. FIG. 13C shows a third layout of the pixel, wherein the first sub-pixel Pa is a trapezoidal pixel, the other portion pertains to the second sub-pixel Pb, and each of the first sub-pixel Pa and the second sub-pixel Pb includes one TFT.

FIGS. 13A to 13C illustrate several examples of the layout. However, one of ordinary skill in the art may use the layout with any other shape to construct the pixel structure of the invention.

Pixel Structure

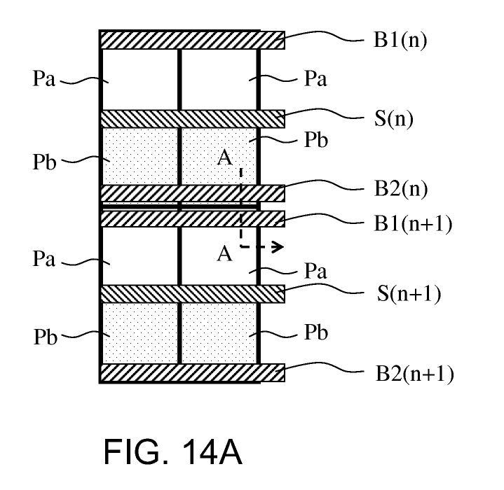

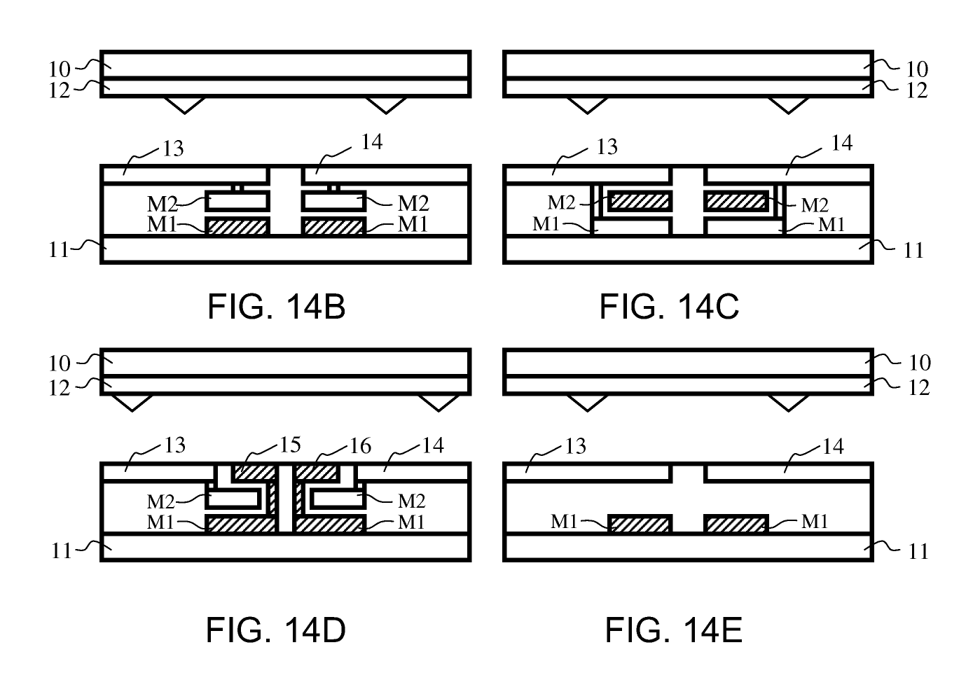

The LCD panel 100 of the first embodiment may have several configurations. Four examples will be described in the following. FIG. 14A is a schematic illustration showing the LCD panel 100 of the first embodiment. FIGS. 14B to 14E are cross-sectional views showing various structures of the LCD panel 100. FIG. 14B is a cross-sectional view taken along a line AA′ to show a first LCD panel structure. The LCD panel 100 includes an upper substrate 10, a common electrode 12, a lower substrate 11, transparent electrodes 13 and 14, and first metal layers M1 and second metal layers M2. The two second metal layers M2 respectively couple the transparent electrodes 13 and 14 to the data lines. The two first metal layers M1 constitute the bias lines B1 and B2. The first metal layer M1 and the corresponding second metal layer M2 constitute the storage capacitor Cₛₜ.

FIG. 14C is a cross-sectional view taken along the line A-A to show a second LCD panel structure, which is different from the first structure in that the transparent electrodes 13 and 14 are electrically connected to the first metal layers M1, and the second metal layers M2 constitute the bias lines B1 and B2. FIG. 14D is a cross-sectional view taken along the line AA′ to show a third LCD panel structure, which is different from the first structure in that the first metal layers M1 are further electrically connected to the transparent electrodes 15 and 16 in order to increase the capacitance of the storage capacitor Cₛₜ. FIG. 14E is a cross-sectional view taken along the line AA′ to show a fourth LCD panel structure, which is different from the first structure in that the second metal layers have been eliminated.

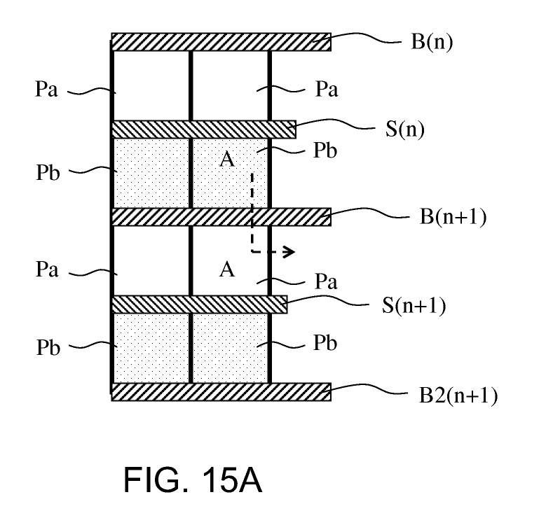

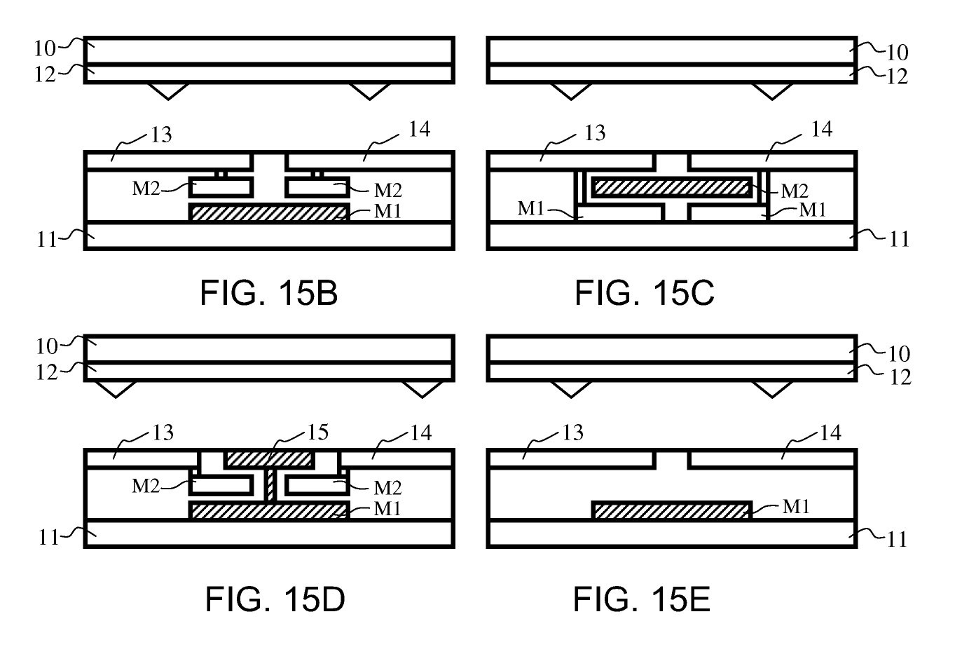

The LCD panel 400 of the second embodiment may have several structures, and four examples will be illustrated. FIG. 15A is a schematic illustration showing the LCD panel 400 of the second embodiment. FIGS. 15B to 15E are cross-sectional views showing various structures of the LCD panel 400. FIG. 15B is a cross-sectional view taken along a line A-A to show a first structure of the LCD panel 400. The LCD panel 400 includes an upper substrate 10, a common electrode 12, a lower substrate 11, transparent electrodes 13 and 14, a first metal layer M1 and two second metal layers M2. The two second metal layers M2 respectively couple the transparent electrodes 13 and 14 to the data lines. The first metal layer M1 constitutes the bias line B. The first metal layer M1 and its corresponding second metal layers M2 constitute the storage capacitor Cₛₜ.

FIG. 15C is a cross-sectional view taken along the line AA′ to show a second structure of the LCD panel 400, which is different from the first structure in that the transparent electrodes 13 and 14 are electrically connected to the first metal layers M1, and the second metal layer M2 constitutes the bias lines B. FIG. 15D is a cross-sectional view taken along the line AA′ to show a third structure of the LCD panel 400, which is different from the first structure in that the first metal layer M1 is further electrically connected to the transparent electrode 15 in order to increase the capacitance of the storage capacitor Cₛₜ. FIG. 15E is a cross-sectional view taken along the line AA′ to show a fourth structure of the LCD panel 400, which is different from the first structure in that the second metal layers have been eliminated.

The embodiments enable the sub-pixels in one pixel of the multi-domain LCD panel to have the driving voltages, which are slightly different from each other, so as to reduce the color difference and enhance the frame stability and the display quality.

While the invention has been described by way of example and in terms of a limited number of embodiments, it is to be understood that the invention is not limited thereto. On the contrary, the present invention is intended to cover various modifications and similar arrangements and procedures, and the scope of the appended claims therefore should be accorded the broadest interpretation so as to encompass all such modifications and similar arrangements and procedures.

What is claimed is:

1. An LCD (Liquid Crystal Display) panel, comprising:
a data line extending in a first direction;
a scan line extending in a second direction substantially perpendicular to the first direction;
a pixel formed at an intersection between the data line and the scan line, the pixel comprising:
a first sub-pixel, which comprises a first switch, a first liquid crystal capacitor and a first storage capacitor, wherein the first switch has a first terminal coupled to the scan line, a second terminal coupled to the data line, and a third terminal coupled to a first terminal of the first liquid crystal capacitor and a first terminal of the first storage capacitor; and
a second sub-pixel, which comprises a second switch, a second liquid crystal capacitor and a second storage capacitor, wherein the second switch has a first terminal coupled to the scan line, a second terminal coupled to the data line, and a third terminal coupled to a first terminal of the second liquid crystal capacitor and a first terminal of the second storage capacitor;
a first bias line electrically connected to a second terminal of the first storage capacitor; and
a second bias line electrically connected to a second terminal of the second storage capacitor, wherein:
when the scan line is enabled, a first data switch and a second data switch turn on to enable a signal on the data line to be transmitted to the first sub-pixel and the second sub-pixel; and
after the scan line is disabled, levels of the first bias line and the second bias line respectively change to make pixel voltages of the first sub-pixel and the second sub-pixel different from each other.

2. The panel according to claim 1, wherein the first bias line has a first level before the scan line is enabled, the first level when the scan line is enabled, and a second level after the scan line is disabled.

3. The panel according to claim 1, wherein the second bias line has a third level before the scan line is enabled, the third level when the scan line is enabled, and a fourth level after the scan line is disabled.

4. The panel according to claim 1, wherein the first bias line has a first level before the scan line is enabled, a second level when the scan line is enabled, and the first level after the scan line is disabled.

5. The panel according to claim 1, wherein the second bias line has a third level before the scan line is enabled, a fourth level when the scan line is enabled, and the third level after the scan line is disabled.

6. The panel according to claim 1, wherein the LCD panel comprises a gate driver, which comprises a plurality of output pins for respectively driving the scan line, the first bias line and the second bias line.

7. The panel according to claim 1, wherein the LCD panel comprises a first gate driver for driving the scan line, and a second gate driver for driving the first bias line and the second bias line.

8. The panel according to claim 7, wherein the first gate driver and the second gate driver are disposed on one side of the LCD panel.

9. The panel according to claim 7, wherein the first gate driver and the second gate driver are disposed on opposite sides of the LCD panel.

10. The panel according to claim 1, wherein the LCD panel comprises a first gate driver and a second gate driver, which are disposed on opposite sides of the LCD panel and commonly drive the scan line, and a third gate driver and a fourth gate driver, which are disposed on the opposite sides of the LCD panel and commonly drive the first bias line and the second bias line.

11. The panel according to claim 1, comprising a plurality of the scan lines defined as first scan lines and second scan lines, and a plurality of the pixels defined as first pixels and second pixels, wherein the first pixels and the second pixels are respectively arranged in directions perpendicular to each other, and the second bias line is shared by the second sub-pixel of the first pixel and the first sub-pixel of the second pixel.

12. The panel according to claim 11, further comprising a bias generating circuit, which is formed on a substrate of the LCD panel, for driving the first bias line and the second bias line according to the first scan line and the second scan line.

13. The panel according to claim 12, wherein the bias generating circuit comprises at least one bias unit, which is electrically connected to the first scan line and the second scan line and is electrically connected to the first bias line and the second bias line.

14. The panel according to claim 1, wherein a phase difference between the levels of the first bias line and the second bias line ranges from 180 to 360 degrees.

15. An LCD (Liquid Crystal Display) panel, comprising:
a data line extending in a first direction;
a scan line extending in a second direction substantially perpendicular to the first direction;
a pixel formed at an intersection between the data line and the scan line, the pixel comprising:
a first sub-pixel, which comprises a first switch, a first liquid crystal capacitor and a first storage capacitor, wherein the first switch has a first terminal coupled to the scan line, a second terminal coupled to the data line, and a third terminal coupled to a first terminal of the first liquid crystal capacitor and a first terminal of the first storage capacitor; and
a second sub-pixel, which comprises a second switch, a second liquid crystal capacitor and a second storage capacitor, wherein the second switch has a first terminal coupled to the scan line, a second terminal coupled to the data line, and a third terminal coupled to a first terminal of the second liquid crystal capacitor and a first terminal of the second storage capacitor;
a first bias line electrically connected to a second terminal of the first storage capacitor; and
a second bias line electrically connected to a second terminal of the second storage capacitor, wherein:
when the scan line is enabled, a first data switch and a second data switch turn on to enable a signal on the data line to be transmitted to the first sub-pixel and the second sub-pixel;
after the scan line is disabled, levels of the first bias line and the second bias line respectively change to make pixel voltages of the first sub-pixel and the second sub-pixel be slightly different from each other; and
the first bias line and the second bias line further respectively change the levels thereof at least one time in a frame time period.

16. An LCD (Liquid Crystal Display), comprising:
a source driver;
a gate driver for outputting a scan signal;
a bias generating circuit for outputting a first bias signal and a second bias signal according to the scan signal; and
a LCD panel, which comprises:
a data line, which extends in a first direction and is electrically connected to the source driver;
a scan line, which extends in a second direction substantially perpendicular to the first direction, for receiving the scan signal;
a pixel formed at an intersection of the data line and the scan line, the pixel comprising:
a first sub-pixel, which comprises a first switch, a first liquid crystal capacitor and a first storage capacitor, wherein the first switch has a first terminal coupled to the scan line, a second terminal coupled to the data line, and a third terminal coupled to a first terminal of the first liquid crystal capacitor and a first terminal of the first storage capacitor; and
a second sub-pixel, which comprises a second switch, a second liquid crystal capacitor and a second storage capacitor, wherein the second switch has a first terminal coupled to the scan line, a second terminal coupled to the data line, and a third terminal coupled to a first terminal of the second liquid crystal capacitor and a first terminal of the second storage capacitor;
a first bias line, which receives the first bias signal and is electrically connected to a second terminal of the first storage capacitor; and
a second bias line, which receives the second bias signal and is electrically connected to a second terminal of the second storage capacitor, wherein:
when the scan line is enabled, a first data switch and a second data switch turn on to enable a signal on the data line to be transmitted to the first sub-pixel and the second sub-pixel; and
after the scan line is disabled, levels of the first bias signal and the second bias signal respectively change to make pixel voltages of the first sub-pixel and the second sub-pixel be slightly different from each other.
